(19) United States
(12) Patent Application Publication
(10) Pub. No.: US 2007/0164128 A1
(43) Pub. Date: Jul. 19, 2007

(54) Anti-dry start device

(76) Inventor: John F. Kresge, Clarks Summit, PA (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 11/643,274

(22) Filed: Dec. 21, 2006

Related U.S. Application Data
(60) Provisional application No. 60/755,967, filed on Jan. 3, 2006.

(51) Int. Cl. B05B 1/28; F04B 49/06

(52) U.S. Cl. 239/104; 417/44.4

(57) ABSTRACT

An anti-dry start device is provided for preventing the operation of a powered pressure washer in the absence of sufficient inlet fluid pressure, the device comprising a pressure switch removably mounted into a fitting installed in the inlet line to the pressure washer, the device further comprising an electrical interconnection between the pressure switch and an ignition system of the pressure washer, whereby the pressure switch is adapted to disrupt power to the pressure washer ignition switch when the inlet pressure is below a preset threshold.

### RELATED INVENTION

This application is related to and claims priority from U.S. Provisional Application No. 60/755,967, filed Jan. 3, 2006, entitled “Anti-Dry Start Device”, the disclosure of which is incorporated herein by reference in its entirety.

### FIELD OF THE INVENTION

The invention relates to powered pressure washers and more particularly to a device for preventing powered pressure washers from being started in a dry condition.

### BACKGROUND OF THE INVENTION

Powered pressure washers are connectable to a water supply (e.g., a residential water line or other standard water supply via a hose or hose connection) and include a pump unit for discharging a jet of water at an increased pressure. Powered pressure washers are used for a variety of purposes including cleaning of decks, driveways and other surfaces, preparation of walls for painting and for removal of graffiti, etc. Known powered pressure washers include gasoline-powered pressure washers and electrically powered pressure washers.

Starting a powered pressure washer without water being delivered to the washer is known as dry starting. Dry starting of a powered pressure washer can result in damage to the pump unit of the powered pressure washer. Operation of a powered pressure washer with a reduced flow of water delivered to the powered pressure washer (e.g., a low pressure condition) can also lead to damage of the pump unit. Such a condition might result for example if a hose supplying water to the pressure washer becomes constricted or kinked. The cost of repairing or replacing a damaged pump unit can be very expensive, sometimes representing as much as two-thirds of the replacement cost for the entire powered pressure washer.

### BRIEF DESCRIPTION OF THE DRAWINGS

FIG. 1 is a side elevation view of an anti-dry start device according to an exemplary embodiment of the invention.

FIG. 2 is a side elevation view of an anti-dry start device according to an alternate embodiment of the invention.

### DESCRIPTION OF THE INVENTION

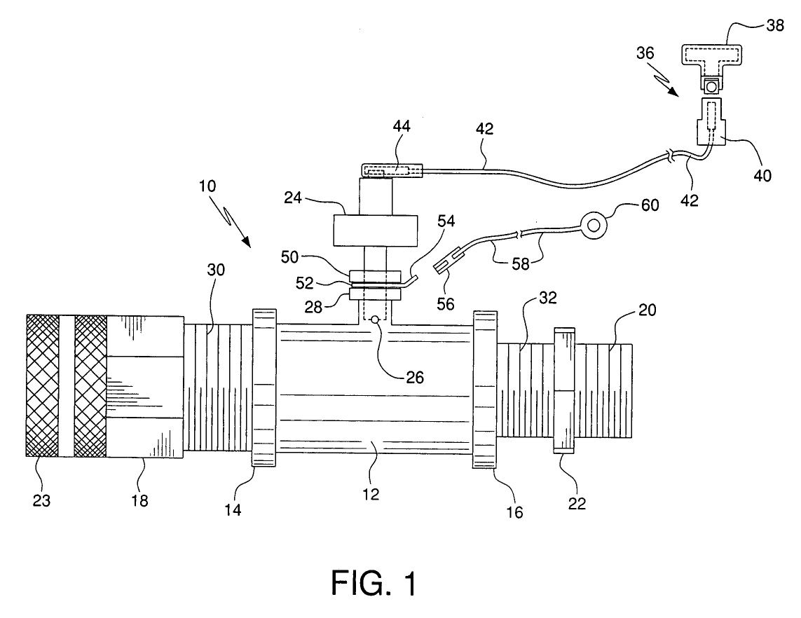

Referring to the drawing, there is shown in FIG. 1 an anti-dry start device 10 for a powered pressure washer. As described below in greater detail, the anti-dry start device 10 is adapted to prevent a powered pressure washer connected to the device 10 from being started unless water is being delivered to the device 10 (e.g., from a hose connected to a residential water line). The powered pressure washer most preferably includes a gas-powered engine. The present invention, however is not so limited and has potential application to other types of powered pressure washers (e.g., electrical, hydraulic, etc.).

The anti-dry start device 10 includes a central body 12 defining an open interior having opposite ends 14, 16 from which water will respectively be received from a source of water (e.g., a hose) and delivered to a powered pressure washer. Adjacent end 14 of central body 12, the device 10 includes a first fitting 18 adapted for attachment to the water source. The depicted device 10 is adapted for attachment to a hose and, therefore, the first fitting 18 preferably includes female hose threads not shown but contained within a female connector 23 located at a first end of the device 10. The threads are preferably sized to connect with a standard garden hose connection or spigot (e.g., ¾ inch hose threads). The device 10 includes a second fitting 22 coupled to end 16 of central body 12. The depicted device 10 is adapted for use with powered pressure washers connectable to a hose for receiving water (e.g., from a residential water line). The second fitting 22, therefore, includes male hose threads 20 adjacent an end of the second fitting to provide for attachment of the device 10 to the powered pressure washer. The threaded fittings are conventional and, therefore, no further discussion is necessary.

The anti-dry start device 10 includes a pressure switch 24 coupled to the central body 12. As shown, the pressure switch 24 is located such that an end 26 of switch 24 is in fluid communication with the interior of central body 12 to respond (e.g., switch) in the presence of water delivered at a sufficient pressure into the central body 12 from a water source. Pressure switches are, per se known, and no further description is necessary.

In the depicted device 10, the central body 12 is embodied as a tee having ¾ inch internal threads (not shown) at opposite ends and an intermediate tap 28 having ¼ inch internal threads. As shown, the ¼ inch internal threads of tap 28 provide for threaded attachment of an externally threaded portion of the pressure switch 24 to the central body 12. In the illustrated embodiment, the first and second fittings 18, 22 are attached to the central body 12, such as with threads. Specifically, the first fitting 18 includes ¾ inch N.P.T. male threads 30 opposite the female connector 23 for threaded attachment of the first fitting 18 to end 14 of central body 12. As shown, the second fitting 22 includes ¾ inch N.P.T. male threads that mate with internal threads formed in the end 16 of central body 12 to couple the second fitting 22 to the central body 12. Preferably, a non-toxic thread sealer is used for the threaded connections. For example a rubber gasket seal may be included in the female connector 23. While the center body 12 in above discussion is described as separate from the first and second fittings, it should be readily apparent that the fittings and the body can be formed as an integral component. Also, while threads are illustrated and discussed, it should be readily apparent that any connection mechanism can be used, such as a bayonet-connection.

The anti-dry start device 10 includes a tee tap connector 36 adapted to provide electrical connection between the pressure switch 24 and the ignition system of a powered pressure washer. Preferably, the device 10 is adapted for connection to a 12 volt DC ignition system, or similar ignition system typically included on gas-powered pressure washers. The tee tap connector 36 includes an insulated female terminal 38 adapted for connection to the ignition system of the powered pressure washer (e.g., by a self-piercing wire connector). The tee tap connector 36 also includes an insulated male terminal 40 adapted for mating connection to the female terminal 38 of the tee tap connector 36. An elongated wire lead 42 provides electrical connection between the tee tap connector 36 and the pressure switch 24. More particularly, the wire lead 42 is coupled at one end to the male terminal 40 of the tee tap connector 36. The opposite end of the wire lead 42 is coupled to an insulated female spade terminal 44, such as by crimping. The spade terminal 44 is, in turn, coupled to the pressure switch 24, such as by clipping the female connector onto a button head or a contact terminal. Preferably the connection is removable for replacement purposes. The depicted wire lead 42 is illustrated with a break to indicate that any suitable length for wire lead 42 could be chosen. However, for most applications a length of 24 inches should be sufficient to extend between the pressure switch 24 and the female terminal 38 of the tee tap connector 36 when the device 10 is connected to a powered pressure washer.

Installation of the anti-dry start device 10 is as follows. The second fitting 22 of device 10 is connected to the powered pressure washer by threadedly engaging the threads 20 of the second fitting 22 with mating threads on the powered pressure washer. The device 10 is also connected to a water supply, for example by threadedly engaging a water hose to the female hose threads of the first fitting 18. Connected in this manner, water that is supplied to the device 10 by the water supply will be delivered to the powered pressure washer via the interior of the central body 12. Electrical connection between the pressure switch 24 of device 10 and the ignition system of the powered pressure washer is then made by engaging the male terminal 40 of the tee tap connector 36 to the female terminal 38 of the tee tap connector 36. As discussed above, the female terminal 38 of the tee tap connector 36 is electrically coupled to the ignition system of the powered pressure washer in a well known manner. The depicted device 10 is adapted for relatively simple installation estimated to take approximately 3 to 5 minutes. As should be apparent from the above description, the pressure switch 24 is connected into the ignition wiring system, preventing ignition unless the pressure switch is activated.

The operation of the anti-dry start device 10 is as follows. The electrical connection between the pressure switch 24 and the pressure washer functions to disable the ignition system of the pressure washer in the absence of pressure applied to the pressure switch 24 by water in the interior of the central body 12. As a result, the powered pressure washer can not be started when water is not being supplied to the pressure washer. The device 10, therefore, desirably serves to protect the pump unit of pressure washer from damage otherwise caused by starting the pressure washer in a dry condition. This serves to prolong pump life and avoid costly pump repairs, which may represent as much as two-thirds the cost of replacing the entire pressure washer.

In some cases, the pressure washer uses a plastic or non-metallic nut that is designed to attach to threads 20 of device 10. Such a configuration could compromise the path to ground, which is used to disable the 12 volt ignition system of the pressure washer unit in the absence of water pressure. Referring to FIG. 1, an optional grounding system is shown. More specifically, the device 10 includes a brass or metallic nut 50, such as a ¼ inch, 18 thread brass hex nut. A ring terminal 52 is located about the threaded end 26 of the switch 24. The ring terminal 52 is preferably a ⅝ inch diameter ring with a male connector pin terminal 54. A female pin terminal 56 is attached to one end of a wire 58 and designed to engage with the male connector pin terminal 54. A ring terminal or other connector 60 is attached to or formed on the other end of the wire 58. The ring terminal 60 would be connected, such as with a screw or bolt, to the pressure washer unit, thus completing the path to ground.

In addition to preventing start of the powered pressure washer in a dry condition, the device 10 also serves to protect a powered pressure from low pressure water conditions that might occur while the pressure washer is running. For example, if a there is ice within the supply hose or the supply hose becomes kinked such that the flow of water to the pressure washer is reduced, the pressure switch will sense the drop in pressure and stop the pressure washer. This feature (e.g., low pressure washer stall) also provides for test of an installed device 10 to ensure that the device is properly functioning to disable the pressure washer from starting or operating in low water pressure conditions.

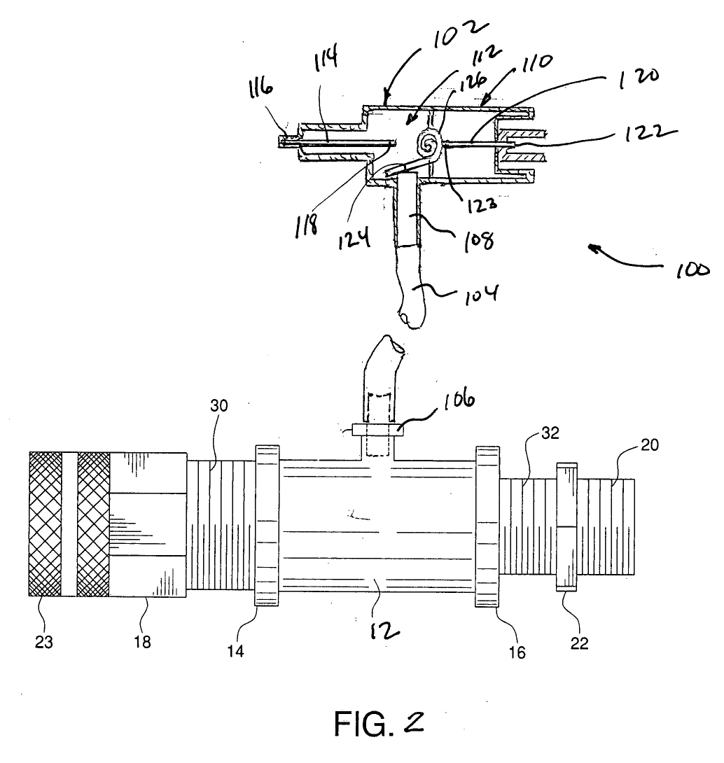

Referring to FIG. 2, an alternate switch system 100 to disengage the ignition system is shown. In this embodiment of the invention, the switch controls the power to the spark plug electrode. the pressure sensor or switch 102 includes a tube 104 that connects to a tap 106. The tap 106 preferably includes barbs or an alternate device for securing the tube onto the tap such that there is fluid communication from the central body 12 through the tap 106 and into the tube 104 for water to flow. The opposite end of the tube 104 connects the a sealed piston 108 mounted within a pressure switch housing 110. Upon the fluid in the tube reaching a threshold pressure, the piston 108 expands into the housing 110.

Located within the housing 110 is a switch mechanism 112 that includes a first electrical line 114 with a first end 116 forming an incoming electrode for connecting with a spark plug wire and a second end 118 forming a contact within the housing. A second electrical line 120 includes a first end 122 forming an outgoing electrode for connecting to a spark plug, and a second end 123 connected to a spring biased switch plate 124. A spring 126 biases the switch plate 124 out of contact with the second end 118 of the first electrical line 114. The spring force is preferably about 10 lb-force. The piston 108 is positioned adjacent to the switch plate such that pressurization of the piston forces the piston to force the switch plate 124 into contact with the second end 118, thereby connecting the first electrode with the second electrode and providing power to the system as described previously. When water pressure in the tube falls below a threshold, the piston transitions away from the housing, disengaging the switch plate from the contact and cutting off the connect between the ignition and the spark plug.

The foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. An anti-dry start device for preventing the operation of a powered pressure washer in the absence of sufficient inlet pressure, comprising:
a sensor adapted to detect a level of fluid pressure at the inlet to the pressure washer;
an electrical switching means interconnected to the sensor for responding to the detected fluid pressure level; and
an electrical communication conduit interconnecting the switching means with the pressure washer so as to disable the pressure washer from operating when the detected fluid pressure is below a preset threshold.

2. An anti-dry start device as recited in claim 1, wherein a pressure switch comprises the sensor and the switching means.

3. An anti-dry start device as recited in claim 2, further comprising a pipe fitting having a first port adapted to be interconnected to a fluid supply, a second port adapted to be interconnected to the inlet of the pressure washer, and a third port adapted to receive the pressure switch.

4. An anti-dry start device as recited in claim 2, wherein the fluid supply is removably interconnected to the fitting and wherein the pressure washer inlet is removably interconnected to the fitting.

5. An anti-dry start device as recited in claim 2, wherein the pressure switch is removably received into the fitting.

6. An anti-dry start device as recited in claim 2, wherein the electrical interconnection conduit comprises a wire adapted to be removably interconnected between the pressure washer and the switching means of the pressure switch.

7. An anti-dry start device as recited in claim 2, further comprising an electrical grounding conduit interconnecting the fitting with an electrical ground on the pressure washer.

8. An anti-dry start device as recited in claim 2, wherein the preset pressure threshold is approximately zero.

9. An anti-dry start device as recited in claim 2, wherein the preset pressure threshold is greater than zero but less than the required inlet pressure to the pressure washer.

10. An anti-dry start device as recited in claim 1, wherein the electrical communication conduit interconnects the switching means with an ignition system of the pressure washer so as to disrupt power to the pressure washer ignition system when the detected fluid pressure is below the preset threshold.

11. An anti-dry start device for preventing the operation of a powered pressure washer in the absence of sufficient inlet pressure, comprising:
a pressure switch having a pressure sensor and an electrical switching means;
a pipe fitting having a first port adapted to be interconnected to a fluid supply, a second port adapted to be interconnected to the inlet of the pressure washer, and a third port adapted to receive the pressure switch;
an electrical communication conduit interconnecting the switching means to an ignition system of the pressure washer so as to disrupt power to the pressure washer ignition system when the detected fluid pressure is below a preset threshold.

12. An anti-dry start device as recited in claim 11, further comprising an electrical grounding conduit interconnecting the fitting with an electrical ground on the pressure washer.
